(19) United States
(12) Patent Application Publication
(10) Pub. No.: US 2026/0336989 A1
(43) Pub. Date: Oct. 29, 2026

(54) FRAMELESS HARDTOP HOIST SYSTEM AND DEVICE

(71) Applicant: LANGE ORIGINALS, LLC, Salt Lake City, UT (US)

(72) Inventor: Carter SMITH, Salt Lake City, UT (US)

(73) Assignee: LANGE ORIGINALS, LLC, Salt Lake City, UT (US)

(21) Appl. No.: 19/661,573

(22) Filed: Apr. 28, 2026

Related U.S. Application Data
(60) Provisional application No. 63/796,189, filed on Apr. 28, 2025.

(51) Int. Cl. B66D 1/60

(52) U.S. Cl. CPC B66D 1/60; B66D 2700/025

(57) ABSTRACT

Disclosed is a hoist system that includes a power unit, a rear hoist strap, and a front hoist strap. The power unit includes a roller. The rear hoist strap may attach to a rear strap. The rear strap may have one or more hooks. The front hoist strap may attach to the front strap. The front strap may attach to one or more hooks.

### PRIORITY CLAIM

This application claims the benefit of and priority to U.S. Provisional Patent Application 63/796,189 filed on Apr. 28, 2025, the entire contents of which are hereby incorporated by reference in their entirety.

### BACKGROUND

The concept of removable roofs for vehicles originated in the earliest forms of transportation, driven by a need for adaptability to varying conditions. In the late 19th and early 20th centuries, horse-drawn carriages often incorporated detachable fabric covers or panels, enabling users to shield themselves from the elements or enjoy open air as desired. With the transition to motorized vehicles, this idea persisted in early automobile designs, which frequently featured optional canvas tops that could be removed or folded back. These initial systems prioritized basic functionality over longevity, offering rudimentary protection but suffering from cumbersome installation and vulnerability to wear.

As vehicle engineering advanced, removable roofs evolved to balance convenience with structural demands. By the mid-20th century, retractable soft tops gained popularity, characterized by fabric roofs that could be lowered manually or mechanically. While widely adopted, these soft tops provided limited insulation, security, and weather resistance compared to fixed metal roofs, prompting exploration into removable hardtops. Around this time, some vehicles introduced retractable rigid roofs that folded into storage compartments via automated mechanisms, marking a notable leap forward. However, these systems were often complex, heavy, and expensive, limiting their broad use.

The late 20th century saw the rise of removable hardtops as modular, manually detachable panels, particularly in rugged or recreational vehicles. These designs used lightweight materials such as fiberglass, allowing drivers to switch between enclosed and open configurations without complex machinery. By the early 21st century, removable hardtops had advanced to include composite and aluminum constructions, reducing weight while preserving durability. Modern systems often feature segmented panels, such as front sections over the occupant area and rear sections over storage spaces, offering enhanced customization and flexibility.

Despite these improvements, contemporary removable hardtop designs face several unresolved challenges. First, the process of installing and removing panels remains time-consuming and labor-intensive, often requiring tools or multiple individuals, which undermines ease of use. For instance, aligning fasteners or latches can be difficult, with components prone to misalignment or degradation over time. Second, the seals between removable sections and the vehicle frame frequently fail to ensure a fully watertight or airtight closure, resulting in leaks, wind noise, or poor thermal insulation, especially in harsh weather or at high speeds. Third, storage of detached panels presents a practical issue; their bulkiness demands significant space, either reducing vehicle cargo capacity or necessitating external storage, which may not always be available. Lastly, even with lighter materials, the weight of hardtops can influence vehicle dynamics or efficiency when attached, while their removal may reduce structural integrity in certain configurations. These persistent drawbacks underscore the need for advancements in removable hardtop technology.

### SUMMARY OF THE DISCLOSURE

Disclosed herein is a frameless hardtop hoist system and device.

### BRIEF DESCRIPTION OF THE DRAWINGS

Non-limiting and non-exhaustive implementations of the disclosure are described with reference to the following figures, wherein similar reference numerals refer to similar parts throughout the various views unless otherwise specified. The advantages of the disclosure will become better understood with regard to the following description and accompanying drawings, where:

FIG. 1 illustrates a perspective view of a frameless hardtop hoist system and device.

FIG. 2 illustrates a side perspective view of a front hook and back hook of a hardtop hoist system.

FIG. 3 illustrates a perspective view of a rear hook of a hardtop hoist system.

FIG. 4 illustrates a perspective view of a power unit of a hardtop hoist system.

FIG. 5 illustrates a perspective view of an anchor of a power unit of a hardtop hoist system.

FIG. 6 illustrates a perspective view of the rear connection system of a hardtop hoist system.

### DETAILED DESCRIPTION

In the following description of the disclosure, reference is made to the accompanying drawings, which form a part hereof, and in which are shown by way of illustration specific implementations in which the disclosure may be practiced. It is understood that other implementations may be utilized and structural changes may be made without departing from the scope of the disclosure.

In the following description, for purposes of explanation and not limitation, specific techniques and embodiments are set forth, such as particular techniques and configurations, in order to provide a thorough understanding of the device disclosed herein. While the techniques and embodiments will primarily be described in context with the accompanying drawings, those skilled in the art will further appreciate that the techniques and embodiments may also be practiced in other similar devices.

Reference will now be made in detail to the exemplary embodiments, examples of which are illustrated in the accompanying drawings. Wherever possible, the same or similar reference numbers are used throughout the drawings to refer to the same or similar parts. It is further noted that elements disclosed with respect to particular embodiments are not restricted to only those embodiments in which they are described. For example, an element described in reference to one embodiment or figure may be alternatively included in another embodiment or figure, regardless of whether or not those elements are shown or described in another embodiment or figure. In other words, elements in the figures may be interchangeable between various embodiments disclosed herein, whether shown or not.

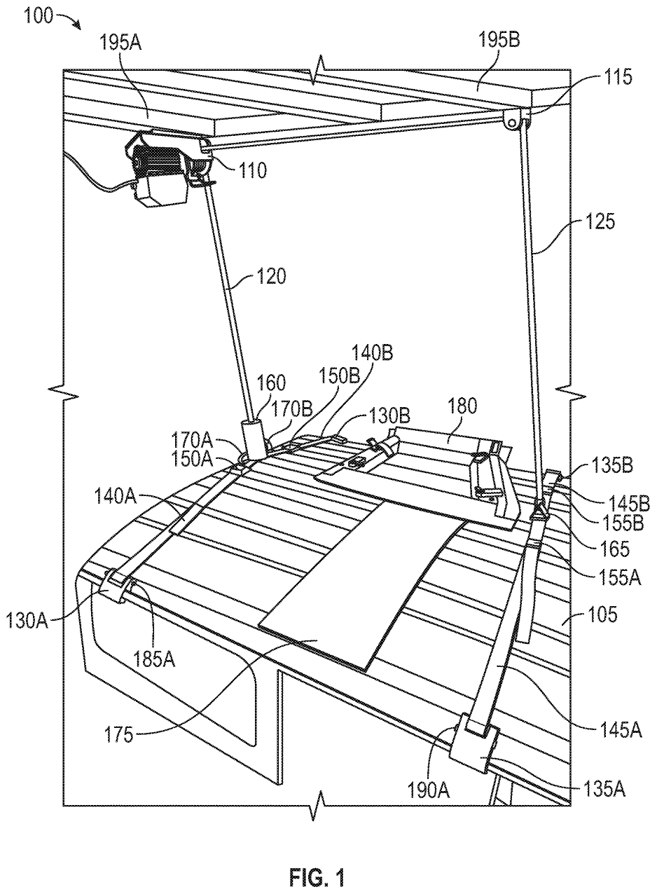

FIG. 1 illustrates a perspective view of frameless hardtop hoist system 100. Hoist system 100 may include power unit 110. Power unit 110 may be powered by a battery, electricity, or various other types of fuel. Power unit 110 may be actuated by a switch on a remote, attached to a wall, or directly on the power unit 110. Alternatively, power unit 110 may be activated by using a computer application on a mobile phone, tablet, or computer. Power unit 110 may be attached at an attachment point 195A. Attachment point 195A may be a beam, truss, rafter, or other stable point that can withstand the weight of both the power unit and the object being lifted, such as removable hardtop 105. Anchor 115 may attach to attachment point 195B. Attachment point 195B may be a beam, truss, rafter, or other stable point that can withstand the weight of both the power unit and the object being lifted, such as removable hardtop 105.

Both power unit 110 and anchor 115 work together to help lift hardtop 105. For example, power unit 110 may include a roller attached to the power unit that rotates upon actuation. As the roller rotates, it collects portions of front and rear hoist straps 120 and 115, wrapping the straps around the roller. Rear hoist strap 120 may be attached to rear coupler 160. Rear coupler 160 may be positioned below power unit 110. Front hoist strap 125 may be attached to front coupler 165. Front coupler 165 may be positioned below anchor 115. As rear hoist strap 120 and front hoist strap 125 wrap around the roller, rear coupler 160 is drawn upwards towards power unit 110, and front coupler 165 is drawn towards anchor 115.

Rear coupler 160 may attach to rear strap 140A-B. Rear coupler 160 may attach to rear straps 140A in between buckles 150A-B. Coupler 160 may also include a guard that may prevent rear hoist 120 from wrapping around the roller. Buckles 150A-B may be attached to rear straps 140A-B. Buckels 150A-B may allow rear straps 140A-B to be adjusted. Buckles 150A may include a frame, plate, box frame, quick release, ratchet, cam, lever, ladder lock, or other buckles known in the art. Front straps 140A-B may also attach to hooks 130A-B, respectively. Buckles 150A-B may allow the straps 140A-B between buckles 150A-B and hooks 130A-B to be lengthened or shortened to accommodate the size of hardtop 105 or to allow for the removal and storage of hoist system 110.

Hooks 130A-B may be sized to attach to hardtop 105 such that, when rear straps 140A-B are tightened, they remain attached to hardtop 105 while hoist strap 120 is wrapped around the roller. As straps 140A-B are tightened, tension may be placed on straps 140A-B that, in turn, may place tension on hooks 130A-B, aiding in the connection between hooks 130A-B and hardtop 105. This tension may also help keep hooks 130A-B in place as the rear hoist strap 120 pulls rear straps 140A-B in an upward direction towards power unit 110. Hooks 130A-B may include hook pads 185A-B (hook pad 185B not seen due to perspective) to protect hooks 130A-B from scuffing up hardtop 105.

Front hoist strap 125 may attach to front coupler 165. Front coupler 165 may attach to front straps 145A-B in between front buckles 155A-B. Front Buckles 155A-B may be attached to front straps 145A-B. Buckels 155A-B may allow front straps 145A-B to be adjusted. Buckles 155A may include a frame, plate, box frame, quick release, ratchet, cam, lever, ladder lock, or other buckles known in the art. Front straps 145A-B may also attach to hooks 135A-B, respectively. Buckles 155A-B may allow the front straps 145A-B between buckles 155A-B and hooks 135A-B to be lengthened or shortened to accommodate the size of hardtop 105 or to allow for removal and storage of hoist system 110.

Hooks 135A-B may be sized to attach to hardtop 105 such that when rear straps 145A-B are tightened, they remain attached to hardtop 105 when hoist strap 125 is wrapped around roller. As straps 145A-B are tightened, tension may be placed on straps 145A-B that, in turn, may place tension on hooks 135A-B, aiding in the connection between hooks 135A-B and hardtop 105. This tension may also help keep hooks 130A-B in place as rear hoist strap 120 pulls rear straps 145A-B in an upward direction towards anchor 115. Hooks 135A-B may include hook pads 190A-B to protect hooks 130A-B from damaging hardtop 105. Pad 190B is not seen due to perspective.

Hoist system 100 may also include mat 175, which may be placed on hardtop 105. Mat 175 may be placed between rear straps 140A-B and front straps 145A-B and positioned on top of hardtop 105. Mat 175 may be made of material that protects hardtop 105 from one or more doors 180. Mat 175 may help keep door 108 from sliding around when placed on top of hardtop 105. Mat 175 may be comprised of material that can be easily rolled for storage purposes.

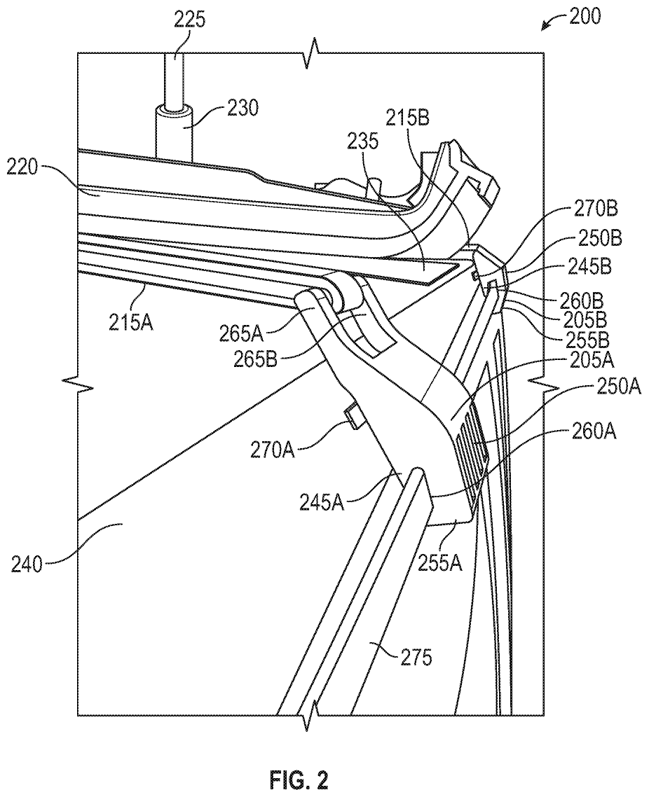

FIG. 2 illustrates a side perspective view of rear hook 205A and front hook 205B of hoist system 200. Front hook 205A may include thumb 245A sized to fit in the space of rail 275. Rail 275 is positioned along the outside edge of hardtop 240. Thumb 245A may be used to provide structure for rail 275 when front strap 215A is tightened. Front hook 205A may also include rail gap 260A, which is sized to fit rail 275. Front hook 205A may also include bottom support 255A. Bottom support 255A is sized to fit under rail 275 of hardtop 240. Bottom support 255A may be used to provide the underlying support of hardtop 240, as through the removal process, it is lifted in an upward direction. Front hook 205A also includes hook pad 270A, which may be attached to the side of front hook 205A closest to hardtop 240. Hook pad 270A may be used to prevent damage to hardtop 240. Hook pad 270A may also be used to keep hook 205A in position, preventing it from sliding back and forth when in use. Front hook 205A connected to front strap 215A, which, when it is tight, thumb 245A, rail gap 260A, and bottom support 255A work together to maintain attachment to 240.

Rear hook 205B may include thumb 245B sized to fit in the space of rail 275. Rail 275 is positioned along the outside edge of hardtop 240. Thumb 245B may be used to provide structure for rail 275 when rear strap 215 A is tightened. Rear hook 205B may also include rail gap 260B, which is sized to fit rail 275. Rear hook 205B may also include bottom support 255B. Bottom support 255B is sized to fit under rail 275 of hardtop 240. Bottom support 255B may be used to provide the underlying support of hardtop 240, as through the removal process, it is lifted in an upward direction. Rear hook 205B also includes hook pad 270B, which may be attached to the side of rear hook 205B closest to hardtop 240. Hook pad 270B may be used to prevent damage to hardtop 240. Hook pad 270B may also be used to keep hook 205B in position to keep it from sliding back and forth when in use. Rear hook 205B connected to rear strap 215B, which, when it is tight, thumb 245B, rail gap 260B, and bottom support 255B work together to maintain attachment to 240.

Hoist system 200 may also include mat 235, which may be placed on hardtop 240. Mat 235 may be placed between rear straps A-B and front straps 215A-B and positioned on top of hardtop 240. Mat 235 may be made of material that protects hardtop 240 from one or more doors 180. Mat 235 may help keep door 220 from sliding around when placed on top of hardtop 105. Mat 235 may be comprised of material that can be easily rolled for storage purposes.

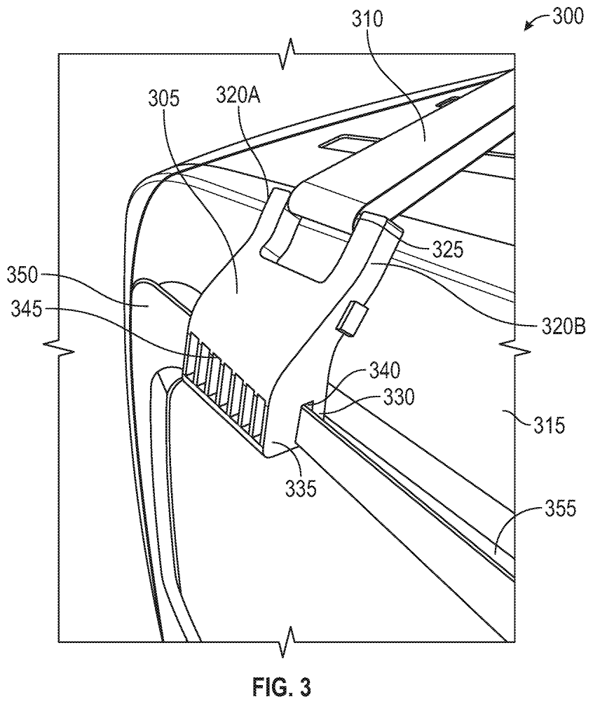

FIG. 3 illustrates a perspective view of rear hook 345 of a hardtop hoist system 300. Rear hook 305 may attach to hardtop 315 by interacting with rail 350. To interact with rail 350, rear hook 305 may include thumb 330, which is inserted into space 315 of rail 350. Thumb 330 may be used to provide structure for rail 350 and connection to hardtop 315. This aid may be further applied when rear strap 310A is tightened. Thumb 330 may also be used to maintain attachment to hardtop rear hook 305, which may also include rail gap 340 that is sized to fit rail 350. Rear hook 305 may also include bottom support 335 that may extend below rail 350. Rear hook 305 may include bridge 345, which may connect to thumb 330 and bottom support 335. Bridge 345 may also be comprised of one or more ribs that run vertically. Ribs may allow for structural integrity while removing excess material. Further, ribs may allow some flexibility that allows the principles of compliant mechanism and friction to function.

On the opposite end of bottom support 335, rear hook 305 may attach to rear strap 310 via cross bar 325. Cross bar 325 may attach to rear hook 305 using arms 320A-B. Cross bar 325 may attach to arm 320A on a first end and to arm 320B on a second end. Below arms, 320A-B or towards the position, bottom support 325 is positioned, with hook pad 355. Hook pad 355 may be positioned on the side nearest to hardtop 315. In practice, when rear strap 310 is pulled tight against cross bar 325, this may pull thumb 345, bottom 355, and bridge 345 together to grasp hardtop 315, facilitating the lifting of hardtop 315.

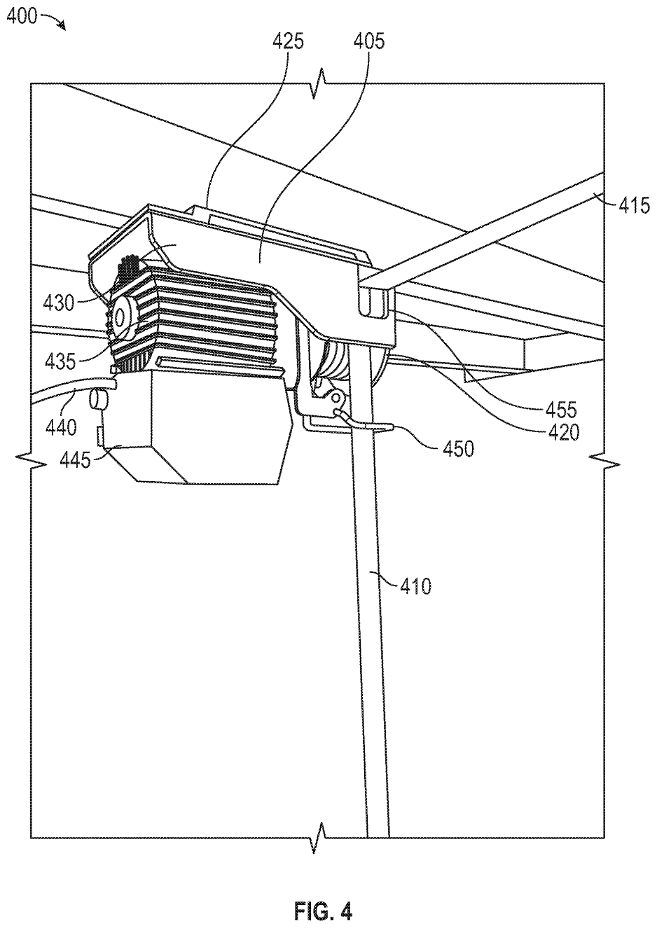

FIG. 4 illustrates a perspective view of power unit 405 of a hardtop hoist system 400. System 400 may include roller 420, rear hoist strap 410, and front hoist strap 415. Power unit 405 may actuate the rotation of roller 420 in a clockwise and/or a counterclockwise direction. Roller 420 may have a channel to receive rear hoist strap 410 and front hoist strap 415. Further, rear hoist strap 410 and front hoist strap 415 may attach to roller 420. Roller 420 may also include a braking system that may activate as a failsafe.

Rear hoist strap 410 may extend towards roller 420 vertically, extending upwards from a hardtop where rear hoist strap 410 is connected to a coupler (similar to rear coupler 160 in FIG. 1) that is connected to one or more rear hoist straps 410 (similar to straps 140A-B in FIG. 1). Accordingly, rear hoist strap 410 may be rolled up in roller 420 from the bottom side of power unit 405 and may pass through guard 450. Guard 450 may be attached to power unit 405 and may help guide rear hoist

### Strap 410 to Roller 420.

This process may occur as indicated in FIG. 1, where hooks 135A-B may be sized to attach to hardtop 105 such that when rear straps 145A-B are tightened, they remain attached to hardtop 105 when hoist strap 125 is wrapped around roller. As straps 145A-B are tightened, tension may be placed on straps 145A-B that, in turn, may place tension on hooks 135A-B, aiding in the connection between hooks 135A-B and hardtop 105. This tension may also help keep hooks 130A-B in place as rear hoist strap 410 pulls rear straps 145A-B in an upward direction towards power unit 110. Hooks 135A-B may include hook pads 190A-B to protect hooks 130A-B from damaging hardtop 105. Pad 190B is not seen due to perspective.

Front hoist strap 415 may extend horizontally towards roller 420. In this manner, front hoist strap 415 may be positioned substantially perpendicular to rear hoist strap 410 prior to entering roller 420. Substantially perpendicular in this circumstance means plus or minus 10%. Accordingly, front hoist strap 415 may be rolled up in roller 420 through side opening 455 disposed in the side of casing bracket 430. Before entering roller 420, front hoist strap 415 may pass through an anchor. The anchor may be positioned above where front hoist strap 415 attaches to the front coupler that attaches to front straps 415 and front hooks. The front hooks ultimately attach to the hardtop at the front end.

This process may occur as indicated in FIG. 1, where hooks 135A-B may be sized to attach to hardtop 105 such that when rear straps 145A-B are tightened, they remain attached to hardtop 105 when hoist strap 125 is wrapped around roller. As straps 145A-B are tightened, tension may be placed on straps 145A-B that, in turn, may place tension on hooks 135A-B, aiding in the connection between hooks 135A-B and hardtop 105. This tension may also help keep hooks 130A-B in place as rear hoist strap 120 pulls rear straps 145A-B in an upward direction towards anchor 115.

Power unit 405 may also include motor 435, which may attach to casing bracket 430. Casing bracket 430 may attach to mounting bracket 425. Mounting bracket 425 may attach to anchor point 460, be it a rafter, truss, floor joist, beam, or other anchor points known in the art above a removable hardtop. Motor 435 may also attach to power compartment 445, which may house the electrical and mechanical components of motor 435. Power unit 405 may also include power source 440 depicted as a power cord. However, power unit 405 may be powered by one or more of AC and DC power through a power cord or a battery, combustible fuels, solar, hydraulics, or any combination known in the art. Power unit 405 may include one or more gears to aid in the lifting of an object.

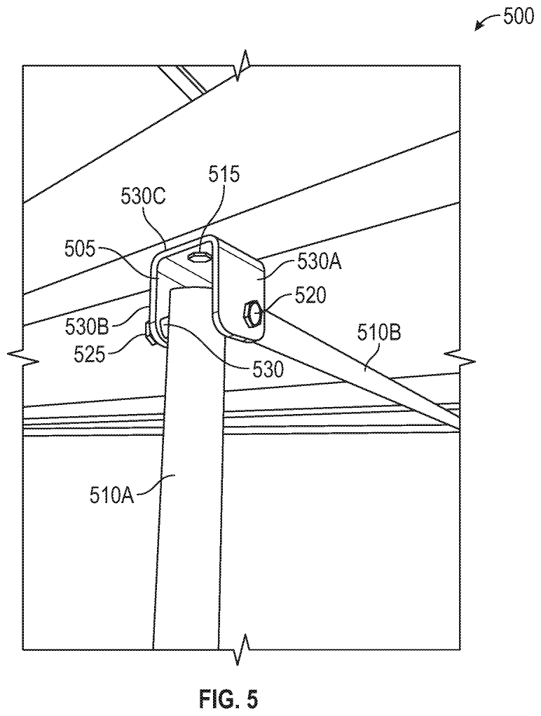

FIG. 5 illustrates a perspective view of anchor 505 hardtop hoist system 500. Anchor 505 may be attached to a rafter, truss, floor joist, beam, or solid anchoring point by connector 515 that may be a bolt, screw, clamp, or other attachment device known in the art. Connector 515 may be connected to or disposed of through upper plate 530C to attach to the solid anchor point. Alternatively, anchor 505 may attach to the upper end of a rafter, truss, floor joist, beam, or solid anchoring point and be held there by friction and gravity. Anchor 505 may also include side plate 530A-B. Anchors 530A-B may extend downwards (when attached) substantially perpendicular to upper plate 530C. Substantially, in this context, means plus or minus 10%. Side plates 530A-B may have rod 535 disposed through or attached to the inside portions of side plates 530A-B. Rod 535 may have one or more attachment points 520 and 525. Rod 535 may include a tube or a rotatable portion that allows the vertical portion of hoist strap 510A to turn to the horizontal portion of hoist strap 510B. As a result, rod 535 may function like a pulley to aid in lifting the hardtop.

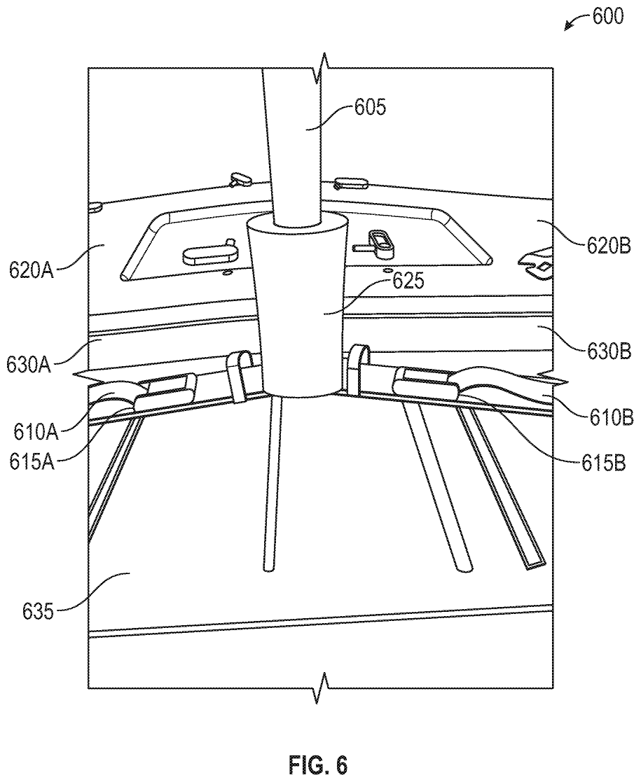

FIG. 6 illustrates a perspective view of the rear connection of a hardtop hoist system 600. Hoist system 600 may include rear strap 610A-B. Rear strap 610A may connect to buckle 615A. Buckel 615A may allow rear strap 610A to adjust. Rear strap 610B may connect to buckle 615B. Buckel 615B may allow rear strap 610B to adjust. Buckles 615A-B may attach to other straps that attach to coupler 625. Coupler 612 connects rear straps 610-A-B to rear hoist strap 605. Coupler 625 may include a guard disposed around the outside of coupler 625. The guard may act as a stopping point when rear hoist strap 605 is wrapped around roller 420 (as depicted in FIG. 4) of the power source, rolls up both front hoist strap 415 (as depicted in FIG. 4) and rear hoist strap 605, lifting hardtop 635 along with doors 620A-B. Hoist system 600 may also include storage straps 630A-B, composed of hook-and-loop material, to aid in storing hoist system 600.

To function system 600 may include elements in use but not depicted in FIG. 6, but depicted in FIGS. 1-5. For example, system 600 may include power unit 405 (as depicted in FIG. 4). Power unit 405, when actuated, may rotate roller 420, which may be connected to front hoist strap 415 (as seen as horizontal hoist strap 510B) and rear hoist strap 605. Rear hoist strap 605, including coupler 625, may be positioned may be positioned below power unit 405 such that rear hoist strap 605 may be rolled up in roller 420 from the bottom up. Alternatively, front hoist strap 415 may be divided into two parts: vertical front hoist strap 510A and horizontal front hoist strap 510B, as in FIG. 5. Accordingly, vertical front hoist strap 510A may pass through anchor 505 before transitioning to horizontal front hoist strap 510B and being moved towards power unit 405 as it is rolled up in roller 420.

Both vertical front hoist strap 510A and rear hoist strap 605 may be connected to front straps 145A-B (as depicted in FIG. 1) by coupler 165. Front straps 145A-B may include hooks 135A-B connected to hardtop 635 towards the front end. Front straps 145A-B may include buckles 155A-B that may be tightened to connect hooks 135A-B to hardtop 635. When vertical front hoist strap 510A is drawn upward towards anchor 505. It pulls upwards on front straps 145A-B that may be attached to hardtop 635 via hooks. Similarly, hoist strap 605 may be connected to rear straps 610A-B. In turn, rear straps may connect to hooks 130A-B (as depicted in FIG. 1). Rear straps 610A-B may include buckles 610A-B that may be tightened to connect hooks 130A-B to hardtop 635. When rear hoist strap 605 is pulled upward towards power unit 405.

The foregoing description has been presented for purposes of illustration. It is not exhaustive and does not limit the invention to the precise forms or embodiments disclosed. Modifications and adaptations will be apparent to those skilled in the art from consideration of the specification and practice of the disclosed embodiments. For example, components described herein may be removed and other components added without departing from the scope or spirit of the embodiments disclosed herein or the appended claims.

Other embodiments will be apparent to those skilled in the art from consideration of the specification and practice of the disclosure disclosed herein. It is intended that the specification and examples be considered as exemplary only, with the true scope and spirit of the invention being indicated by the following claims.

What is claimed is:

1. A hoist system comprising:
a power unit comprising:
a roller;
a rear hoist strap attached to the roller;
a front hoist strap attached to the roller a rear strap attached to the rear hoist strap comprising;
one or more hooks; and
a front strap attached to the front hoist strap comprising:
one or more hooks.

2. The hoist system of claim 1, wherein the power unit further comprises a motor operatively coupled to the roller, the motor rotates the roller to wind the rear hoist strap and the front hoist strap.

3. The hoist system of claim 1, further comprising an anchor mounted to a fixed structure, wherein the front hoist strap passes through or is redirected by the anchor.

4. The hoist system of claim 1, wherein the one or more hooks of the rear strap and the one or more hooks of the front strap engage a rail of a removable hardtop.

5. The hoist system of claim 4, wherein each hook comprises a thumb portion sized to fit into a space of the rail and a bottom support portion sized to extend under the rail.

6. The hoist system of claim 5, wherein each hook further comprises a rail gap sized to receive the rail and a hook pad to protect the hardtop from damage.

7. The hoist system of claim 1, further comprising one or more buckles attached to the rear strap and one or more buckles attached to the front strap, the buckles allow adjustment of the length of the respective straps.

8. The hoist system of claim 1, further comprising a protective mat to be placed on top of the hardtop between the rear strap and the front strap.

9. The hoist system of claim 1, wherein the power unit further comprises a guard to guide the rear hoist strap onto the roller.

10. The hoist system of claim 1, wherein the power unit is to be actuated by at least one of a remote switch, a wall-mounted switch, a switch on the power unit, or a mobile application.

11. The hoist system of claim 1, further comprising a coupler connecting the rear hoist strap to the rear strap, the coupler includes a guard to prevent the rear hoist strap from wrapping improperly.

12. The hoist system of claim 1, wherein the anchor comprises a rod that redirects the front hoist strap from a generally vertical direction to a generally horizontal direction toward the power unit.

13. The hoist system of claim 1, wherein each hook comprises a bridge connecting a thumb portion and a bottom support portion, the bridge including one or more vertical ribs for structural support.

14. The hoist system of claim 1, further comprising storage straps comprising hook and loop material to secure the hoist system for storage.

15. The hoist system of claim 1, wherein the power unit further comprises a braking system to prevent unintended unwinding of the roller.

16. The hoist system of claim 1, wherein the rear hoist strap and the front hoist strap are to lift a removable hardtop.

17. The hoist system of claim 1, wherein the power unit is for mounting to a ceiling structure such as a rafter, truss, or beam.

18. The hoist system of claim 1, further comprising a power source selected from the group consisting of a battery, AC power, DC power, and combinations thereof.

19. The hoist system of claim 4, wherein tightening of the rear strap and the front strap creates tension that helps secure the hooks to the rail of the hardtop during lifting.

20. The hoist system of claim 1, wherein the hooks are such that tension in the rear strap and front strap maintains attachment of the hooks to the hardtop as the hardtop is lifted.
